(19) United States
(12) Patent Application Publication
(10) Pub. No.: US 2002/0010884 A1
(43) Pub. Date: Jan. 24, 2002

(54) Test method for switching to redundant circuit in SRAM pellet

(76) Inventor: Hidekazu Yamazaki, Shiga (JP)

Correspondence Address: ROSENMAN & COLIN LLP, 575 MADISON AVENUE, NEW YORK, NY, 10022-2585, US

(21) Appl. No.: 09/815,552

(22) Filed: Mar. 22, 2001

(30) Foreign Application Priority Data
Mar. 29, 2000 (JP) 2000-095250

(51) Int. Cl. G06F 11/24

(52) U.S. Cl. 714/718

(57) ABSTRACT

First, a test is performed on test items which cannot be recovered to obtain a good item by cell switching including a power-up time circuit current, and a circuit current after writing of “0” to all cells is tested in a pellet which passed the test. Then, a pellet determined as being out of specifications is searched for a cell showing a large current after writing of “0.” Similarly, a cell showing a large current after writing of “1” is searched for. A found cell is regarded as a cell to be switched to a redundant cell together with a faulty cell found in a functional test of all cells.

### BACKGROUND OF THE INVENTION

1. Field of the Invention:

The present invention relates to a test method for finding a defective due to a fault in a cell in a plurality of SRAM (Static Random Access Memory) pellets (hereinafter abbreviated as “pellets”) formed on a wafer, and identifying a faulty cell which can be switched to a redundant cell thereby producing a good item in manufacturing steps of an SRAM (hereinafter referred to as “SRAM device”) having a redundant circuit including a group of redundant cells.

2. Description of the Related Art:

With a larger capacity of a semiconductor SRAM device, it is common practice to provide a redundant circuit thereon for improving yields. The redundant circuit includes a group of redundant cells having a plurality of cells similar to primary cells in the SRAM such that any of the primary cells which is faulty and nonfunctioning is switched to a redundant cell to change the SRAM device which would be defective if it included only the primary cells into a good item, thereby improving yields. Such switching is performed by burning a fuse or connecting an antifuse in a pellet on a wafer.

To perform the switching, it is necessary that a number of pellets formed on a wafer are sequentially tested to find a defective pellet, and if the content of the defect can be changed into a good one by switching to a redundant cell, a faulty primary cell (hereinafter abbreviated as “cell”) is identified. In other words, for a pellet which cannot be changed into a good item by switching to a redundant cell, it is unnecessary that a faulty cell is searched for with much time and a fuse is burnt for the switching.

Thus, in a conventional test method for switching to a redundant cell, for example, a function test is performed in which data “0” and data “1” are sequentially written to and read from all cells which have been found to be within specifications for various items including a circuit current in a standby state (a state where no writing or reading are performed), and if no functional defective cell is found, the determination of being good is made, or if a functional defective cell is found, that is recorded and switched to a redundant cell.

To ensure the specifications of the circuit current during standby, in manufacturing steps, tests are performed on a circuit current (hereinafter referred to as “power-up time circuit current”) with power turned on and no writing or reading performed, a circuit current (hereinafter referred to as “post-0 writing circuit current”) after data “0” is written to all cells, and a circuit current (hereinafter referred to as “post-1 writing circuit current”) after data “1” is written to all cells. A pellet exceeding predetermined specifications is determined as a defective and is not set as a subject to be switched to a redundant cell. This is because each of the aforementioned circuit currents is obtained by adding the current in a cell to the current in other peripheral circuits, and it is not easy to identify a particular cell showing an extraordinarily large current. Even when such a cell is identified with much time, a reduced current in that cell not in use after switching to another cell is obtained only in some modes, and this approach is not regarded as an efficient one.

Next, description is made for a cell in an SRAM device. FIG. 1 is a circuit diagram of cell 100. Cell 100 comprises storage transistor Q1 and load resistance R1 connected in series at node N1 in which load resistance R1 is connected to high-potential power line VDD and transistor Q1 is connected to low-potential power line VSS. Similarly, cell 100 further comprises storage transistor Q2 and load resistance R2 connected in series at node N2 in which load resistance R2 is connected to high-potential power line VDD and transistor Q2 is connected to low-potential power line VSS. Gates of transistors Q1 and Q2 are cross-connected to nodes N2 and N1 on the opposite sides, respectively, to constitute a flip-flop circuit. Cell 100 also comprises selection transistor Q3 connecting node N1 to digit line D and selection transistor Q4 connecting node N2 to digit line D*. Digit line D* is a line provided with a voltage opposite to that applied to digit line D, i.e. H or L. Such a digit line is often represented with a bar (-) added on top of D but is represented as “D*” in this specification. Both gates of selection transistors Q3 and Q4 are connected to word line W. Each of transistors Q1, Q2, Q3, and Q4 is an N channel MOS type transistor, for example.

Such cell 100 is disposed at each of intersections of a number of word lines w and a number of paired digit lines D and D* to constitute a group of main cells in the SRAM device. In writing, a pair of digit line D and digit line D* connected to cell 100 of interest is selected to apply a voltage at L to digit line D and a voltage at H to digit line D*, for example. Similarly, word line W connected to that cell 100 is selected to apply a voltage at H thereto. Then, selection transistors Q3 and Q4 are turned ON, and a voltage at L and a voltage at H are applied to node N1 and node N2, respectively. Storage transistor Q1 is then turned ON and transistor Q2 are turned OFF. After the writing, the voltage at node N1 and the voltage at node N2 are maintained at L and H, respectively, even after voltage at word line w is changed to L and selection transistors Q3 and Q4 are turned OFF. If this state is defined, for example, as “0,” data “0” is stored. In contrast, when writing is performed such that a voltage at H and a voltage at L are applied to node N1 and node N2, respectively, cell 100 stores and holds data “1.” In reading, digit line D or digit line D* connected to cell 100 of interest is selected to connect a circuit for detecting a voltage, for example. In addition, word line W connected to that cell 100 is selected to apply a voltage at H thereto. Then, selection transistors Q3 and Q4 are turned ON to apply the voltage at node N1 or node N2 to digit line D or digit line D*. The voltage at node N1 or node N2 is thus detected to read the stored content. writing and reading of both data “0” and data “1” are sequentially performed as described above for each cell 100, and if a functional defective cell is found, that cell is not used and switched to similar cell 100. A plurality of cells 100 for such switching are disposed as redundant cells in a redundant circuit. Circuit switching is performed, for example, with fuse burning or the like such that a redundant cell is connected to digit line pair D and D* to which a defective cell is also connected, and word line w which is connected to the defective cell and would be selected if no defect was present is not selected, but another word line connected to the redundant cell is selected. Thus, the defective cell, although not used, is not separated physically from power line VDD or VSS, and selection transistors Q3 and Q4 in that cell are simply not turned ON.

In recent years, however, the SRAM device is also used in a cellular phone or mobile device, in which case low power consumption is particularly required. In such a so-called low power SRAM device, strict specifications of a circuit current during standby cause reduced yields. Thus, the present invention provides improved yields by identifying, as easily as possible, a cell showing an abnormal current which can become normal by switching to a redundant cell in a pellet with a fault in a cell out of circuit current specifications, and by switching that identified cell to a redundant cell to obtain a good item.

The power-up time circuit current is a circuit current with which the power is turned ON but word line W still remains at L in cell 100. At this point, if storage transistors Q1, Q2 and load resistances R1, R2 keep balance as designed, it is indeterminate whether transistor Q1 or transistor W2 is turned ON. However, in an abnormal state where such a large current flows as to be a main cause of excess over the circuit current specifications in particular cell 100, balance is often lost and it is assumed that one of the ON states repeatedly occurs. In this case, even when such cell 100 is identified, and the use thereof is stopped and switching to a redundant cell is performed, that cell 100 not in use only prevents selection transistors Q3 and Q4 from being turned ON and always maintains the state at the measurement of the power-up time circuit current, thereby producing no effect for reducing the circuit current in this pellet. Thus, a pellet out of specifications of the power-up time circuit current is not regarded as a candidate for recovery.

### SUMMARY OF THE INVENTION

Thus, the present invention attempts to identify a cell showing an extraordinarily large current after data “0” or data “1” is written thereto in a pellet whose circuit current on power-up is within specifications, and to switch the identified cell to a redundant cell, thereby changing the pellet out of the circuit current specifications after data writing into a good item.

To solve the aforementioned problem, the present invention provides a method of test for identifying a faulty cell in an SRAM pellet to switch the faulty cell to the redundant cell included in the SRAM pellet, comprising the steps of: testing a circuit current before writing after power-up, testing a circuit current after writing of one of data “0” and “1” to all cells in a pellet which passed the last test, searching for a faulty cell showing a large current after writing of the one data in a pellet which did not pass the last test, and if such a faulty cell is identified, setting the identified cell to a cell requiring switching; testing a circuit current after writing of the other data to all cells, searching for a faulty cell showing a large current after writing of the other data in a pellet which did not pass the last test, and if such a faulty cell is identified, setting the identified cell to a cell requiring switching.

According to the aforementioned test method, even when a faulty cell is not separated physically from a power line and selection transistors are simply not turned ON in switching the faulty cell to a redundant cell, a faulty cell showing a large current after writing of data “0” or data “1” is identified in a pellet whose circuit current before writing and reading after power-up is within specifications and the identified cell is regarded as a cell requiring switching, and the selection transistors are not turned ON after switching, thereby maintaining the state before writing and reading after power-up (a state where an extraordinarily large current is not present).

Description is made for an example of a cell fault mode in which a current is at a normal value before writing and reading after power-up but becomes large after writing. For example, as faulty cell 200 shown in FIG. 2, when a substantially small resistance value is shown due to load resistance R1 with an extraordinarily small resistance value or a leak current path from high-potential power line VDD toward node N1, an increased voltage at node N1 precedes an increased voltage at node N2 on power-up. Thus, start-up is made in such a state that storage transistor Q1 is turned OFF and storage transistor Q2 is turned ON (a state where data “1” is written). Since storage transistor Q1 is turned OFF, the abnormality in load resistance R1 does not appear in a circuit current. Writing of data “0” turns storage transistor Q1 ON (storage transistor Q2 OFF) to flow an extraordinarily large circuit current due to the substantially small load resistance R1.

As faulty cell 300 shown in FIG. 3, when a leak current path is present from node N1 toward low-potential power line Vss, an increased voltage at node N1 lags behind an increased voltage at node N2 on power-up. Thus, start-up is made in such a state that storage transistor Q1 is turned ON and storage transistor Q2 is turned OFF (a state where data “0” is written). Since storage transistor Q1 is turned ON and load resistance R1 is normal, the influence of the leak current path from node N1 to low-potential power line Vss does not appear in a circuit current writing of data “1” turns storage transistor Q1 OFF (storage transistor Q2 ON) to flow a leak current through load resistance R1 on which otherwise no current flows.

### BRIEF DESCRIPTION OF THE DRAWINGS

FIG. 1 is a circuit diagram showing a cell in an SRAM device;

FIG. 2 is a circuit diagram showing a cell which shows a normal current after power-up and a large current after writing of data “0” thereto;

FIG. 3 is a circuit diagram showing a cell which shows a normal current after power-up and a large current after writing of data “1” thereto;

FIG. 4 is a flow chart showing a test method of an embodiment of the present invention; and

FIG. 5 is a flow chart showing steps (search method) for identifying a faulty cell included in the flow chart in FIG. 4.

### DETAILED DESCRIPTION OF THE PREFERRED EMBODIMENTS

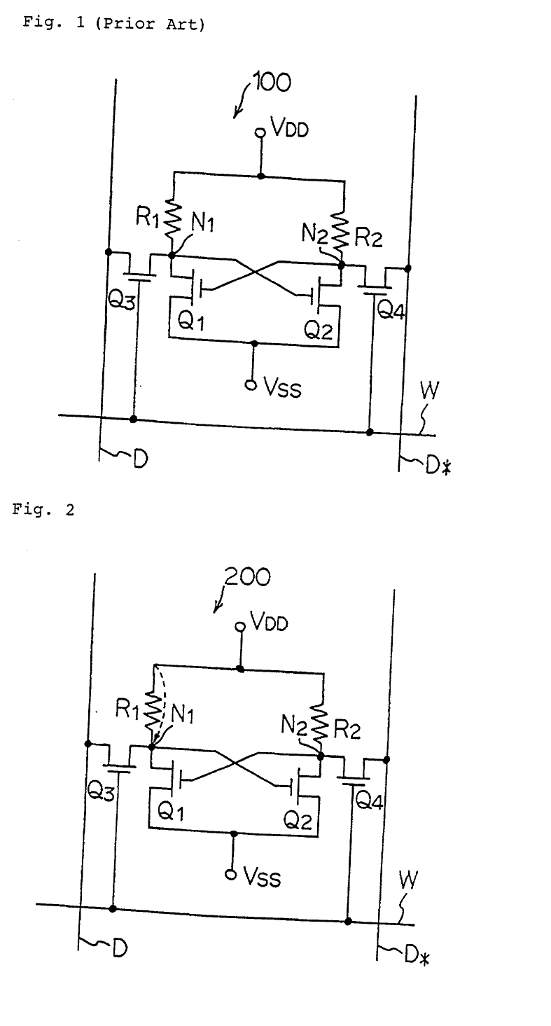

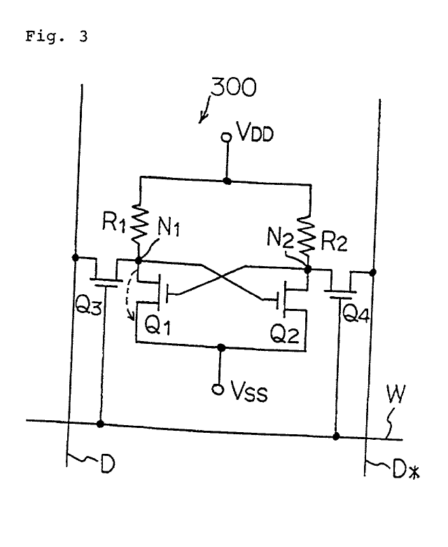

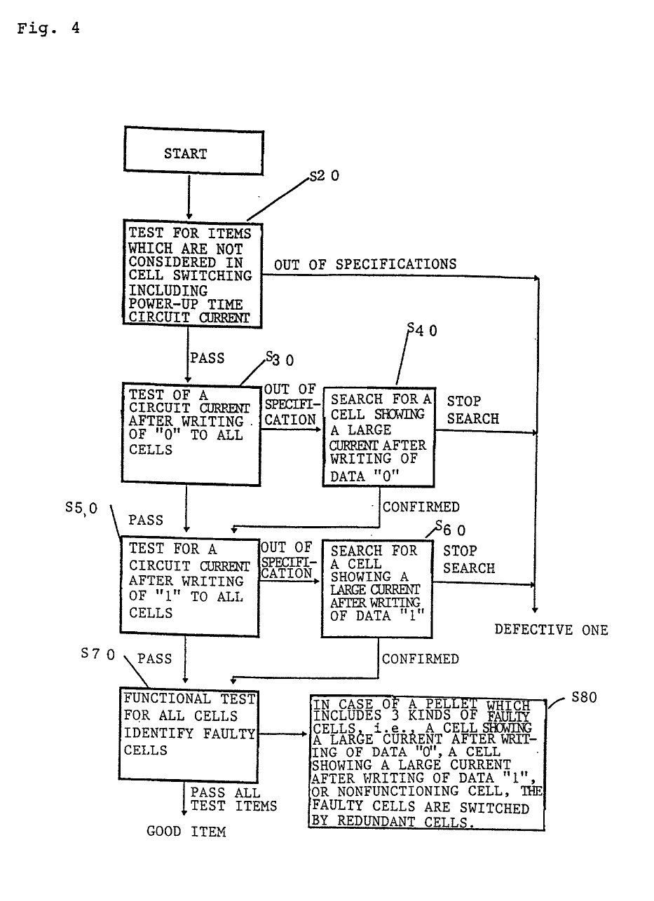

A cell in an SRAM generally includes a pair of circuits each comprising a load element and a storage transistor connected in series to constitute a flip-flop circuit. The load element may be a resistance as illustrated in FIG. 1 or a transistor complementary to the storage transistor, and a test method of the present invention is applicable to both cases.

An SRAM with a large capacity includes a group of redundant cells for switching of a normal cell, if faulty, to change it into a good item. After the formation of a number of pellets on a wafer, each pellet is tested. If a defect is surely caused by a faulty cell, and switching to a redundant cell can result in a good item, switching steps are performed. The test method of the present invention is used at that time. The test method is preferable especially when selection transistors are always turned OFF without physically separating a faulty cell from a power line in the switching from the faulty cell to a redundant cell.

In the test method of the present invention, a conventionally common functional test for writing and reading is performed on all cells, and if a functional defective cell is found in a pellet although the pellet is within other specifications, the cell is switched to a redundant cell. In addition, the test method attempts to improve yields by identifying, in a pellet out of circuit current specifications during standby caused by a fault in a cell, a faulty cell in a mode which can be changed into a good item by switching to a redundant cell, by switching the cell to a redundant cell, and by changing the cell into a good item.

As described above, when a faulty cell is not separated physically from a power line but isolated by preventing selection transistors from being turned ON in the switching from the faulty cell to a redundant cell, a defective pellet with a large circuit current before writing or reading after power-up cannot be recovered by switching of cells even if the defect results from a fault in the cell. Thus, for a pellet which passed a test of this item, a circuit current after writing of data “0” to all cells is tested, and if the result shows deviation from specifications, it is apparently caused by a faulty cell. If the faulty cell is identified with a search and switched to a redundant cell, a good item is likely to be obtained. Similarly, a circuit current after writing of data “1” to all cells is tested, and if the result shows deviation from specifications, a faulty cell is identified with a search since the result is apparently caused by the faulty cell, and the cell is switched to a redundant cell, thereby obtaining a good item probably.

In the test method of the present invention, first, a variety of test items which are not considered in switching of cells are tested, and a power-up time circuit current of circuit currents during standby is tested. For only the pellets which passed the test, circuit currents after writing of data of “0” or “1” to all cells are tested for both “0” and “1,” and if deviation from specifications is present, a cell showing a large current is searched for in the state where data “0” or “1” is written. If such a cell is identified, it is regarded as a cell requiring switching. It goes without saying that, as conventional, in a pellet which passed a variety of test items which are not considered in switching including the power-up time circuit current, writing and reading functions of data “0” and “1” are tested in all cells (cells requiring switching which show a large current when data “0” is written and cells requiring switching which show a large current when data “1” is written may be excluded), and if a nonfunctioning cell is found, the cell is regarded as a cell requiring switching.

To find a cell showing an extraordinarily large current after writing of data of “0” or “1” even if the current value is normal at power-up, a reliable method is to check all cells one by one. For example, for a pellet out of specifications due to a large circuit current after writing of data “0” to all cells even if the circuit current is at a normal value at power-up, the power is once turned off, and then the power is again turned on to set all the cells to the state at power-up. Next, for each of the cells, data “0” is written in turn and a circuit current is measured to find a cell showing an extraordinarily large current (beyond a defined value) as compared with the preceding value (a circuit current at power-up for the first cell), and any cell found is regarded as a cell requiring switching. Similarly, a search can be made when data “1” is written.

While the search of all the cells one by one as described above is reliable and uses a relatively simple program for the search, a drawback of a long time taken for the search is presented. This is because it takes a long time to achieve a stable circuit current after writing of data although the data writing can be performed in a very short time, and the time period from the completion of the writing to the completion of measurement of the circuit current required for measurement with good repeatability is longer than the time taken for writing to all the cells one by one. Thus, the aforementioned method takes a long time since it requires the number of measurements of the circuit current substantially equal to the number of the cells.

To address this, for example, since the number of faulty cells is significantly lower than the number of all the cells in general, all the cells are first classified into two and then a check is made to determine whether a faulty cell is included in one of the two groups, and next, a check is made to determine whether a faulty cell is included in the other group. The group including no faulty cell is not subjected to a subsequent search. For the group including a faulty cell, a similar search for a cell group which does not require a subsequent search is repeated to finally identify a faulty cell. Such a method is carried out fast. Specifically, for finding a cell showing a large current after writing of data “0,” for example, the power is once turned off and again turned on to set all the cells with no writing or reading. Next, data “0” is written to all the cells in one of the groups and a circuit current is measured. If a large current is shown, a faulty cell is included in the group which is then set as a search target. If a large current is not shown, a faulty cell is not included in the group which is then out of a search target. Next, the power is again turned on, and data “0” is written to all the cells in the other group and a circuit current is measured to check whether a faulty cell is included. Thereafter, cell groups are narrowed down to find a cell group including a faulty cell with a similar procedure. In other words, the method narrows down cell groups by removing, from a subsequent search target, a cell group in which the absence of a faulty cell can be ensured. An appropriate method may be selected from methods including the aforementioned one and others in consideration of distribution of the occurrences of faulty cells or the number of redundant cells.

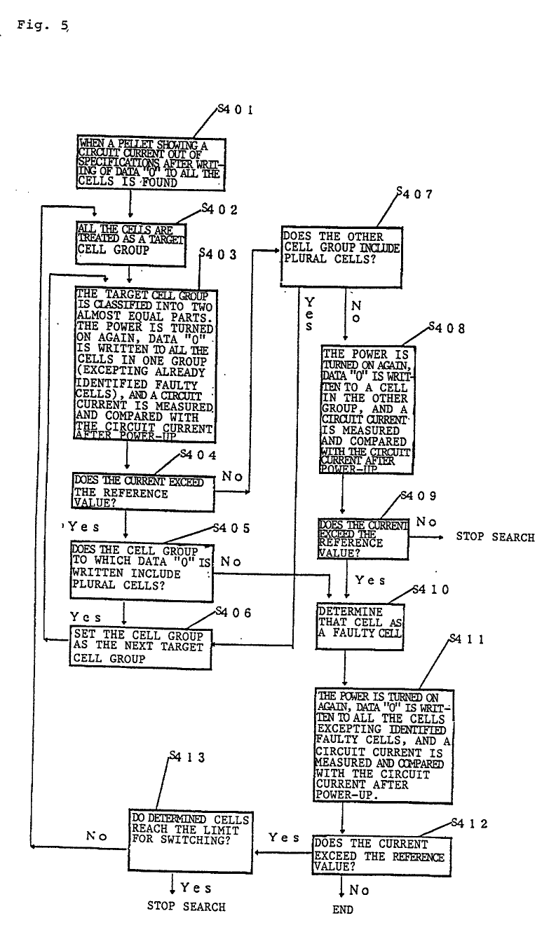

An embodiment of the present invention is described with reference to the drawings. FIG. 4 is a flow chart for describing the test method of the embodiment. The test is performed with a procedure shown in FIG. 4 for all of a number of pellets completed on a wafer. Each of the pellets comprises a group of redundant cells in addition to a group of primary cells such that a faulty primary cell, if any, can be switched to a redundant cell. The switching is performed, for example, by burning a previously provided fuse to select one of the redundant cells without selecting the faulty primary cell which otherwise be selected and accessed. Thus, the faulty cell is not separated physically from a power line.

(1) First, “test for items which are not considered in cell switching” at S20 is performed. In all (or almost) of such test items, a defect cannot be recovered to obtain a good item by cell switching. “Power-up time circuit current” is included in these test items. The item refers to a circuit current measured before writing is performed, and too large a value is regarded as being out of specifications. This value is recorded and used in a subsequent search for a faulty cell. A pellet regarded as being out of specifications for these items is treated as a faulty one, and subsequent tests are not performed thereon.

(2) For the pellets which passed all the items in the aforementioned “test for items which are not considered in cell switching” (S20), “test of a circuit current after writing of “0” to all cells” (S30) is performed. The same specifications as those of “power-up time circuit current” are generally used as specifications in this case. In this test, data “0” is sequentially written to all the cells and then a circuit current is measured. A cell group showing a value out of specifications includes a faulty cell which flows a large current in response to writing of data “0.”

(3) For the pellets regarded as being out of specifications in “test of a circuit current after writing of “0” to all cells” (S30), “search for a cell showing a large current after writing of data “0” (S40) is performed. In this test, a cell showing a large current in response to writing of data “0” is identified and recorded. The specific method in the embodiment is later described.

Since the number of redundant cells included in a pellet is limited, a number of faulty cells exceeding the limit, if present, cannot be switched. Thus, if faulty cells exceeding the limit are found, the search is stopped even if a cell which has not been identified remains, and that pellet is regarded as a defective one and subsequent tests are not performed thereon.

(4) For the pellets which passed “test of a circuit current after writing of “0” to all cells” (S30), or for the pellets which were regarded as being out of specifications in that test and underwent the search for identifying a cell showing a large current in response to writing of data “0” and the record of that faulty cell, next, “test for a circuit current after writing of “1” to all cells” (S50) is performed. The same specifications as those of “power-up time circuit current” are generally used as specifications in this case. This test is performed similarly to “test of a circuit current after writing of “0” to all cells” (S30). For the pellets regarded of being out of specifications, “search for a cell showing a large current after writing of data “1”” (S60) is performed similarly to the aforementioned case. In addition, when the number of faulty cells is too high in a pellet, the search is also stopped and that pellet is regarded as a defective one similarly to the aforementioned case.

(5) For the pellets which passed “test of a circuit current after writing of “1” to all cells” (S50), or for the pellets which were regarded as being out of specifications in that test and underwent the search for identifying a cell showing a large current in response to writing of data “1” and the record of that faulty cell, next, “functional test for all cells” (S70) is performed. In this test, each cell is checked to determine whether data “0” can be read (stored) after writing of data “0” and whether data “1” can be read after writing of data “1,” and a cell with no storage function is recorded as a faulty cell.

The pellets which passed all of the aforementioned test items (the pellets which does not include a nonfunctioning cell in the case of “functional test of all cells” (S70)) are good items which do not require cell switching. The pellets including a faulty cell identified in “search for a cell showing a large current after writing of data “0”” (S40), “search for a cell showing a large current after writing of data “1”” (S60), or “functional test for all cells” (S70) are regarded as items requiring cell switching, and the identified faulty cells are recorded with their addresses as cells requiring switching. After all the pellets on a wafer are tested similarly, the resultant data is sent together with the wafer to a circuit switching step for performing a switching step of cells (S80).

According to the aforementioned test method of the embodiment, the circuit current after the writing of data “0” to all the cells is first tested, and then the circuit current after the writing of data “1” to all the cells is tested, and finally, the functional test of the cells is performed. However, the order of three test items may be arbitrary. A higher efficiency of the test can be achieved by first testing a test item in which a number of faulty cells are frequently found in a pellet to the extent of stopping the search and thus setting that pellet as a defective one.

Next, description is made for a search method in the embodiment for identifying a faulty cell showing a large current after writing of data of “0” or “1.” The case of writing of data “0” is described as a representative example since substantially the same methods are used for writing of data “0” and writing of data “1.” While the two search methods have been described earlier in this section, the method of the embodiment differs from those in that it first identifies a first faulty cell with the minimum number of measurements of circuit currents and then a check is made to determine whether another faulty cell is present. If another defective cell is not present, the search is ended. If another defective cell is present, a second faulty cell is identified with a procedure similar to the preceding one in all the cells except the identified faulty cell, and those steps are repeated subsequently. In this method, processing can be performed in a short time when only one faulty cell is often present and a program for the test is configured with relative ease, but efficiency is low when a number of faulty cells are present.

FIG. 5 is a flow chart illustrating a method for identifying a cell showing a large current after writing of data “0” in the embodiment. As shown in FIG. 5, the following steps are performed.

(1) When a pellet showing a circuit current out of specifications after writing of data “0” to all the cells is found (S401), all the cells are treated as a target cell group (S402), and the target cell group is classified into two almost equal parts. The power is turned ON after it is once turned OFF, data “0” is written to all the cells in one group, and a circuit current is measured and compared with the previously stored circuit current after power-up (S403). When the current exceeds the reference value (S404), it is determined that a faulty cell is included in that cell group. To identify the faulty cell, similar processing is repeated on the cell group set as the next target cell group (S406) for narrowing down the cells.

However, when the measured circuit current after writing in the one target cell group is not large (S404), the other target cell group is regarded as including a faulty cell and treated as the next target cell group.

When narrowing down the cells proceeds until writing is performed to one cell and a large circuit current is shown (S405), that cell can be determined immediately as a faulty cell. However, when a faulty cell may be present in the other group (the circuit current in the one group is not large) and the cells in the other group is narrowed down to one (S407), the power is again turned ON after it is once turned OFF, writing is then performed only to that cell and a circuit current is measured (S408), and the large circuit current is recognized (S409) to determine that cell as a faulty cell (S410).

When writing is performed only to one cell obtained by narrowing down the cells and then the circuit current is measured, the value may not be large (S409). This situation occurs, for example, when a pellets includes no cell showing a significantly large current but has a number of cells showing a rather large current which is not regarded as abnormal, thereby rendering the entire pellet out of circuit current specifications. The search is stopped since this search program cannot address such a case, and that pellet is regarded as a defective one. While it is contemplated that faulty cells can be identified in such a pellet with a more strict reference value for determination, switching cannot be made if the number of the many cells identified as faulty cells exceeds the number of prepared redundant cells.

Once a single faulty cell is determined in this manner, the power is again turned on after it is once turned off, then writing is made to all the cells except the cell determined as faulty, and a circuit current is measured (S411) to check whether another faulty cell is present (S412). If the circuit current is not large and the determination that another faulty cell is not present is made, the search is ended.

If the circuit current is large and the determination that another faulty cell is present is made, a search similar to that described above is repeated with all the cells regarded as a target cell group. It should be noted that, when the target cell group is classified into two and writing is made to one of the two groups (S403) in the second search or later, writing is not made to a cell which has been determined as faulty.

As describe above, a pellet including a plurality of faulty cells is subjected to repeated searches for determining the faulty cells one by one. However, if too many faulty cells are present and the number exceeds the number of prepared redundant cells, switching cannot be made. To avoid this, the procedure returns to the repeated search if the number of determined cells and those addresses do not reach the limit for switching, or if they reach the limit, the search is stopped and that pellet is regarded as a defective one (S413).

While the aforementioned description is for the method of searching for a faulty cell showing a large current in a state where data “0” is written, a method of searching for a faulty cell showing a large current in a state where data “1” is written is similarly performed only by writing different data, and description thereof is omitted.

According to the method of searching for a faulty cell of the embodiment, the advantage of reduced time for the search is obtained if only one faulty cell is often present. The program for the search is relatively simple.

However, if a larger number of faulty cells are present, large losses are involved. Thus, the target cell group for identifying a second faulty cell or later is changed from all the cells as in the aforementioned case to the cells except the cell group (the cell group determined “No” in S404 in FIG. 5) for which the preceding search can ensure that no faulty cell is included. With such a change, the program is complicated but a higher efficiency is achieved.

According to the test method of the embodiment, since it is possible to recover some of items out of current specifications which conventionally are not regarded as subjects to be recovered by switching to a redundant cell but discarded as defective items, yields are improved.

As described above, according to the test method of the present invention, it is possible in manufacturing steps of an SRAM device to find with relative ease a pellet out of specifications of a circuit current during standby due to a fault in a cell, and to identify a faulty cell which can be recovered by switching to a redundant cell, thereby improving yields.

What is claimed is:

1. A method of test for identifying a faulty cell in an SRAM pellet to switch said faulty cell to a redundant cell included in said SRAM pellet, comprising the steps of;
testing a circuit current before writing after power-up, testing a circuit current after writing of one of data “0” and “1” to all cells in a pellet which passed the last test, searching for a faulty cell showing a large current after writing of said one data in a pellet which did not pass the last test, and if such a faulty cell is identified, setting said identified cell to a cell requiring switching;
testing a circuit current after writing of the other data to all cells, searching for a faulty cell showing a large current after writing of said other data in a pellet which did not pass the last test, and if such a faulty cell is identified, setting said identified cell to a cell requiring switching.

2. A method of test for identifying a faulty cell in an SRAM pellet to switch said faulty cell to a redundant cell included in said SRAM pellet, comprising the steps of:
a first test step of testing various test items which are not considered in switching of cells including a circuit current before writing after power-up;
a second test step of testing a circuit current after writing of one of data “0” and “1” to all cells in a pellet which passed said first test step;
a third test step of searching for a faulty cell showing a large current after writing of said one data, in a pellet which did not pass said second test step, if any, and if such a faulty cell is identified, setting said identified cell to a cell requiring switching;
a fourth test step of testing a circuit current after writing of the other data to all cells in a pellet which passed said first test step;
a fifth test step of searching for a faulty cell showing a large current after writing of said other data, in a pellet which did not pass said fourth test step, if any, and if such a faulty cell is identified, setting said identified cell to a cell requiring switching; and
a sixth test step of testing writing and reading functions of data “0” and data “1” in all cells in a pellet which passed said first test step (however, a cell requiring switching identified at said third test step or said fifth test step may be excluded), and if a nonfunctioning cell is found, setting said cell to a cell requiring switching.

3. The method of testing for switching to a redundant circuit in an SRAM pellet according to claim 1, wherein said step of searching for a faulty cell showing a large current after writing of said one data or said step of searching for a faulty cell showing a large current after writing of said other data includes the substeps of classifying a search target cell group into two, writing the data to one of the groups and measuring a current circuit, and if the result of said measurement shows that a faulty cell is probably included, setting said one group to the next search target cell group, or if the result of said measurement shows that no faulty cell is probably included, setting the other group to the next search target cell, and repeating such substeps for narrowing down cells to determine a faulty cell.

4. The method of testing for switching to a redundant circuit in an SRAM pellet according to claim 2, wherein said step of searching for a faulty cell showing a large current after writing of said one data or said step of searching for a faulty cell showing a large current after writing of said other data includes the substeps of classifying a search target cell group into two, writing the data to one of the groups and measuring a current circuit, and if the result of said measurement shows that a faulty cell is probably included, setting said one group to the next search target cell group, or if the result of said measurement shows that no faulty cell is probably included, setting the other group to the next search target cell, and repeating such substeps for narrowing down cells to determine a faulty cell.
